(19) United States
(12) Patent Application Publication
(10) Pub. No.: US 2014/0042348 A1
(43) Pub. Date: Feb. 13, 2014

(54) CHOKE VALVE WITH SHORT BONNET

(71) Applicant: T-3 PROPERTY HOLDINGS, INC., Houston, TX (US)

(72) Inventor: Lane MCCASKILL, Houston, TX (US)

(73) Assignee: T-3 PROPERTY HOLDINGS, INC., Houston, TX (US)

(21) Appl. No.: 13/948,529

(22) Filed: Jul. 23, 2013

Related U.S. Application Data
(60) Provisional application No. 61/680,858, filed on Aug. 8, 2012.

(51) Int. Cl. F16K 31/04

(52) U.S. Cl. CPC F16K 31/047
USPC 251/129.11

(57) ABSTRACT

The disclosure provides a choke valve with a body having a flow path therethrough; a sealing member coupled to the choke body and having ports through which fluid can flow; a control sleeve aligned with the sealing member along a longitudinal axis and configured to cover the ports to restrict flow in the flow path; a stem coupled to the control sleeve and configured to move the control sleeve along the longitudinal axis to cover the ports; a drive bushing rotationally coupled to the stem; an actuator coupled to the drive bushing and configured to rotate the drive bushing; a bonnet coupled to the choke body and having a bore that longitudinally engages the control sleeve; and an anti-rotation surface formed in each of the bonnet and the control sleeve to resist rotation of the control sleeve and the stem when the drive bushing is rotated around the stem.

### CROSS REFERENCE TO RELATED APPLICATIONS

This application claims the benefit of U.S. Provisional Application No. 61/680,858, filed Aug. 8, 2012.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure relates generally to valves and actuation of the valves. More specifically, the disclosure relates to a system of valves for the oil field industry and industrial applications and a method for actuating such valves.

2. Description of the Related Art

Valves are typically actuated manually or by power through turning an internal stem to move a sealing member, such as a plug, gate, or seal. For example, a choke type of valve (herein “choke”) can be used to restrict the amount of fluid flowing through the valve on a long term basis.

FIG. 1 is a typical split cross sectional schematic view of a prior art choke with the left side of the figure showing the choke partially closed and the right side of the figure showing the choke open. The choke 100 includes a body 101 with a bonnet 106 held to the body by a retainer 110, typically referred to as a wing nut. An adapter 114 attaches to the bonnet on one end and some other component on the other end, such a position indicator 124 or a multi-turn output actuator 123.

The bonnet 106 is used to attach or encase some of the moving actuator parts along a longitudinal axis 128. Choke bonnets for manual or actuated high-pressure applications have typically employed a drive bushing 118 attached to the actuator 123. The drive bushing 118 is threadably and rotationally engaged with the choke stem 104 that is mounted through a bore in the bonnet 106. The choke stem 104 also engages with one or more keys 158 that slide in one or more key slots 160 that run along the stem bore within the bonnet. The keys 158 prevent the stem 104 from rotating in the bonnet 106 while the drive bushing 118 rotates around the stem, and are thus called anti-rotation keys. The stem 104 is attached to a control sleeve 150. The control sleeve 150 is slidably engaged with a sealing member 103 that includes side ports 125. The sealing member 103 is fixedly located in the body 101 in a seat 102 and has a seal that engages the body.

In operation starting from an open position, the actuator 123 rotates the drive bushing 118 around the stem 104 that is locked from rotating. The threads in the drive bushing 118 thus slidably move the stem 104 and control sleeve 150 downward toward the body 101 along the longitudinal axis 128 to at least partially cover the ports 125 with the control sleeve to at least partially close or “choke” the valve so that fluid flow in the flow path 130 is restricted or stopped. To open the valve, the actuator reverses direction to rotate the drive bushing in the opposite direction, which pulls upward the stem 104 and control sleeve 150 toward the actuator and exposes the ports 125 to allow fluid to flow therethrough.

To provide clearance for the longitudinal movement of the stem 104 and control sleeve 150, a shoulder 152 of the body 101 and a corresponding shoulder 154 of the control sleeve 150 are separated by a space 156 that varies in length depending on the longitudinal position of the control sleeve relative to the body, as seen by comparing the left and right portions of FIG. 1. A corresponding length for the keyway slot 160 is needed to allow clearance from the stem 104 with the key 158 to move longitudinally. Thus, the bonnet 106 has a certain length to accommodate the length of the keyway slot 160 needed for the stroke of the movement of the stem 104.

All of these mechanisms require that the bonnet 106 have a minimal overall length. However, in some installations, a long bonnet will interfere with other equipment in close proximity. A long bonnet can also increase production cost and make handling the bonnet during maintenance more awkward.

There remains a need for an improved system and method for a choke with a short bonnet that can still be operational through the full stroke of a typical choke valve, but with a shortened bonnet.

### BRIEF SUMMARY OF THE INVENTION

The solution is to take modify the mechanisms that add to the overall length and synergistic adapt the mechanisms. In at least one embodiment, the keys on the stem and the section of the bonnet that requires keyways can be eliminated and thus the corresponding structure removed from the bonnet. To prevent the stem from rotating, an anti-rotation element can be coupled to the control sleeve at the end of the stem and interface with a corresponding surface on the bonnet. In at least one embodiment, one or more parallel flat surfaces on the outside diameter of the control sleeve end of the stem can interface with one or more parallel flat surfaces on the end of the bonnet. The combination can significantly reduce the overall height of the bonnet and related assemblies on the choke.

The present disclosure provides a choke valve system, comprising: a choke body having a flow path therethrough; a sealing member coupled to the choke body and having one or more ports through which fluid can flow in the flow path; a control sleeve longitudinally aligned with the sealing member along a longitudinal axis and configured to at least partially cover the ports to restrict flow in the flow path and at least partially uncover the ports to allow flow in the flow path; a stem coupled to the control sleeve along the longitudinal axis and configured to move the control sleeve along the longitudinal axis to cover and uncover the ports; a drive bushing rotationally coupled to the stem; an actuator coupled to the drive bushing and configured to rotate the drive bushing; a bonnet coupled to the choke body and having a bore that longitudinally engages the control sleeve; and an anti-rotation surface formed in each of the bonnet and the control sleeve to resist rotation of the control sleeve and the stem when the drive bushing is rotated around the stem.

### BRIEF DESCRIPTION OF THE SEVERAL VIEWS OF THE DRAWINGS

FIG. 1 is a typical split cross sectional schematic view of a prior art choke with the left side of the figure showing the choke partially closed and the right side of the figure showing the choke open.

FIG. 2A is an exemplary split cross sectional schematic view of a choke according to the disclosure herein with the left side of the figure showing the choke closed and the right side of the figure showing the choke open.

FIG. 2B is an exemplary split cross sectional schematic view of a choke according to the disclosure herein.

FIG. 3A is a reference cross sectional schematic view of the choke of FIGS. 2A and 2B.

FIG. 3B is a detailed split cross sectional schematic view of a portion of the choke with a bonnet, control sleeve, and anti-rotation elements.

FIG. 4 is a perspective schematic view of one exemplary embodiment of a bonnet according to the disclosure.

FIG. 5 is a side schematic view of one exemplary embodiment of a control sleeve according to the disclosure.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art how to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. Where appropriate, elements have been labeled with alphabetical suffixes (“A”, “B”, and so forth) to designate various similar aspects of the system or device. When referring generally to such elements, the number without the letter may be used. Further, such designations do not limit the number of elements that can be used for that function.

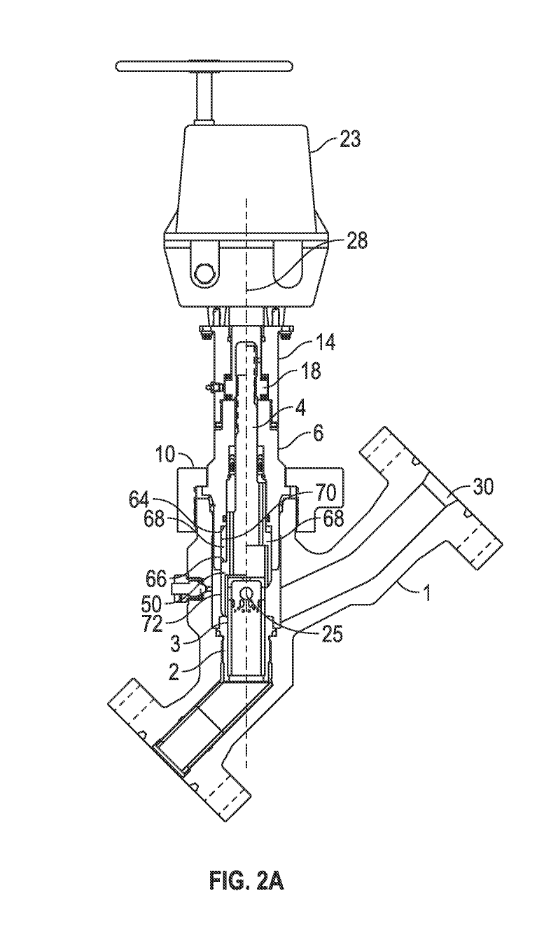

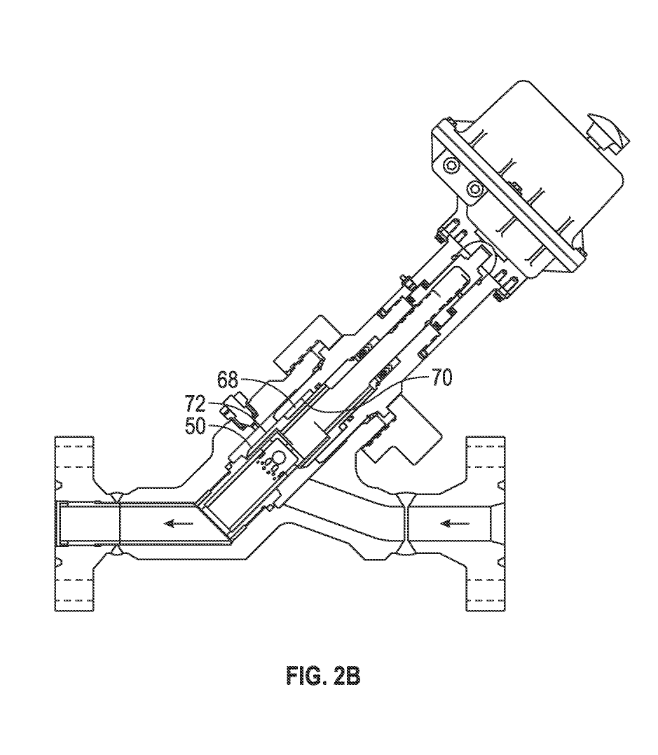

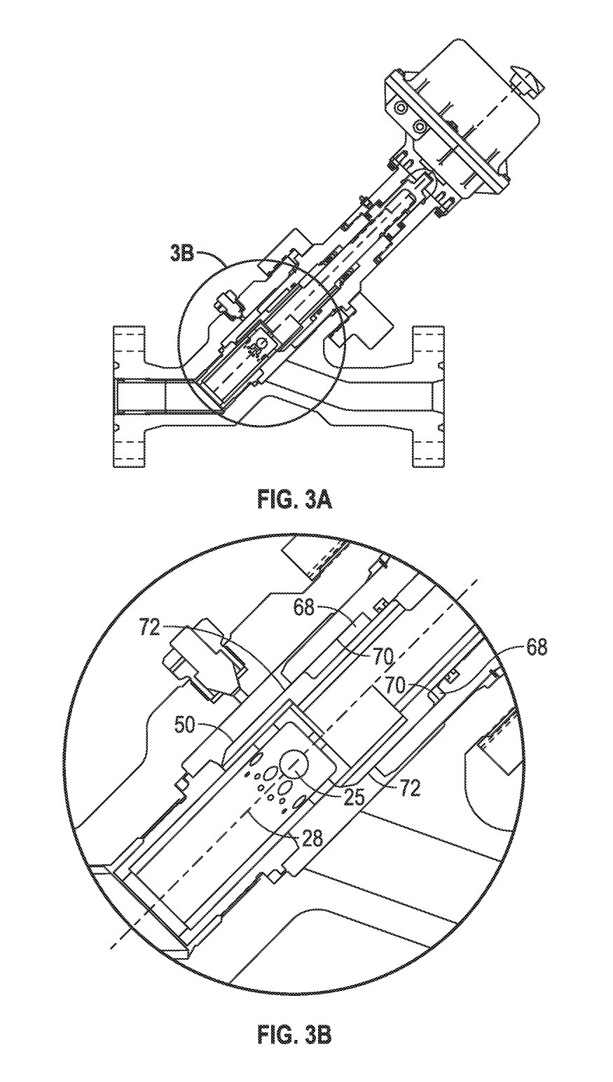

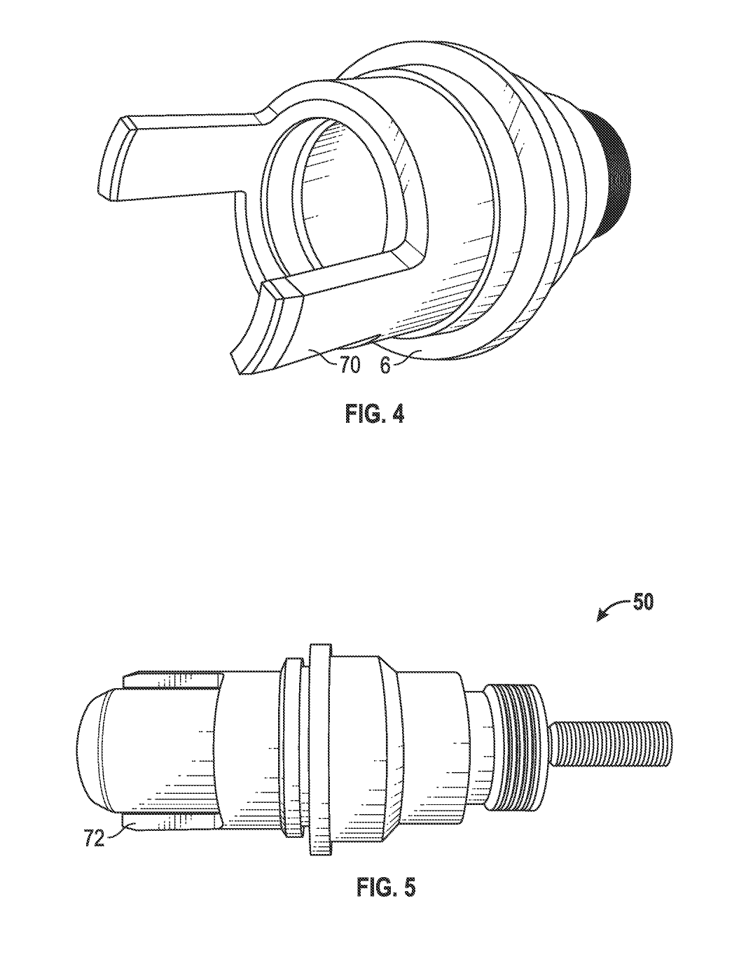

FIG. 2A is an exemplary split cross sectional schematic view of a choke according to the disclosure herein with the left side of the figure showing the choke closed and the right side of the figure showing the choke open. FIG. 2B is an exemplary split cross sectional schematic view of a choke according to the disclosure herein. FIG. 3A is a reference cross sectional schematic view of the choke of FIGS. 2A and 2B. FIG. 3B is a detailed split cross sectional schematic view of a portion of the choke with a bonnet, control sleeve, and anti-rotation elements. FIG. 4 is a perspective schematic view of one exemplary embodiment of a bonnet according to the disclosure. FIG. 5 is a side schematic view of one exemplary embodiment of a control sleeve according to the disclosure. The Figures will be described in conjunction with each other.

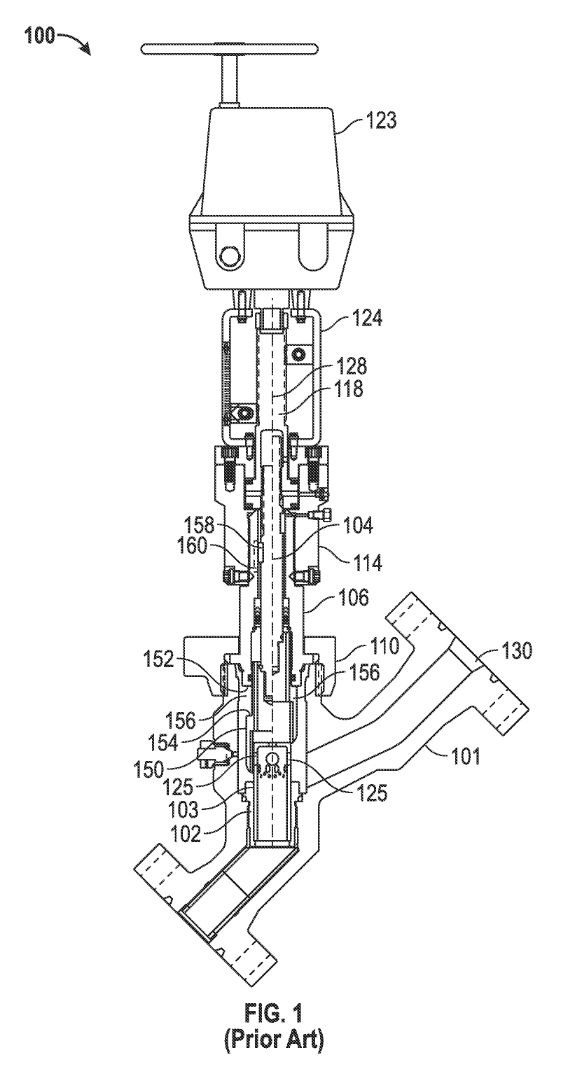

The choke is shown as a Y-body design, but it could be implemented in an angle body, globe body, and other choke designs known in the field. The assembly resembles the assembly in FIG. 1 in several functions, but differs in at least the method, elements, and location of such elements for restricting the rotation of the stem to produce a relatively shortened bonnet for the choke valve.

In general, the choke includes a choke body 1 with a flow path 30 therethrough that is restricted by the interaction of a movable control sleeve 50 at least partially covering side ports 25 formed in a sealing member 3 that is fixedly positioned in a seat 2 of the body. A choke stem 4 is coupled to the control sleeve 50 and moves longitudinally along a longitudinal axis 28 through a bonnet 6 that is coupled by a retainer 10 to the body 1. An adapter 14 couples to the bonnet 6 on one end and some other component such as a multi-turn output actuator 23 on the other end. A drive bushing 18 in the adapter 14 is coupled to the actuator 23. The drive bushing 18 is threadably and rotationally engaged with the stem 4. The actuator 23 rotates the drive bushing 18 that in turn rotates around the stem 4 and moves the stem up and down the longitudinal axis 28.

In contrast to the typical choke assembly, the key 158 and keyway slot 160 are eliminated that resulted in the long bonnet 106 in the prior art FIG. 1. The relatively shorter bonnet 6 in FIGS. 2A-4 is the result. However, the stem 4 needs to be isolated from rotation in order for the drive bushing 18 to move in and out the stem 4 and the control sleeve 50 to cover and uncover the ports 25 in the sealing member 3 along the longitudinal axis 28. The present disclosure uniquely places anti-rotation elements in the region of the control sleeve 50.

One or more anti-rotation elements 70 can be formed on the bonnet 6 in the region of the control sleeve 50. The anti-rotation elements 70 can be one or more flat surfaces or other shaped surfaces. Corresponding anti-rotation elements 72 can be formed on the control sleeve 50, such as one or more mating flat surfaces. The anti-rotation element 70 can be a slot on the bonnet, as shown in FIG. 4. The anti-rotation element 72 can be a lug on the control sleeve, as shown in FIG. 5. Other anti-rotation elements can include less or more numbers of flat surfaces, splines with a mating receiver, or even one or more keys and keyways in the control sleeve.

Since the control sleeve 50, and the stem 4 coupled to the control sleeve, are prevented from rotating by the anti-rotation element 70 of the bonnet and anti-rotation element 72 of the control sleeve, the drive bushing 18 moves the stem 4 along the longitudinal axis 28 of the stem in and out of the choke as the drive bushing is rotated. The stem 4 in turn moves the control sleeve 50 over the ports 25 of the sealing member 3 to restrict flow and off of the ports to allow flow and thus change the flow rate through a flow path 30 of the choke.

To provide clearance for the longitudinal movement of the stem 4, a shoulder 64 of the body 1 and a corresponding shoulder 66 of the control sleeve 50 are separated by a space 68 that varies in length depending on the longitudinal position of the control sleeve relative to the body 1, as seen by comparing the left and right portions of FIGS. 2A-3B. However, in this design, a corresponding length for the keyway slot, such as the keyway slot 160 in FIG. 1, is no longer needed to allow clearance from the stem to move longitudinally.

Other and further embodiments utilizing one or more aspects of the inventions described above can be devised without departing from the spirit of Applicant's invention. For example, the stem of the choke could be restrained with a various numbers of anti-rotation surfaces, some of which are referenced herein and others can be used as would be understood by a person with ordinary skill in the art when provided the teachings herein with the goal that the typical design of a choke valve be changed to reduce the length of the assembly and particularly the bonnet.

Further, the various methods and embodiments of the choke valve can be included in combination with each other to produce variations of the disclosed methods and embodiments. Discussion of singular elements can include plural elements and vice-versa. References to at least one item followed by a reference to the item may include one or more items. Also, various aspects of the embodiments could be used in conjunction with each other to accomplish the understood goals of the disclosure. Unless the context requires otherwise, the word “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unitary fashion. The coupling may occur in any direction, including rotationally.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to protect fully all such modifications and improvements that come within the scope or range of equivalent of the following claims.

What is claimed is:

1. A choke valve system, comprising:
a choke body having a flow path therethrough;
a sealing member coupled to the choke body and having one or more ports through which fluid can flow in the flow path;
a control sleeve longitudinally aligned with the sealing member along a longitudinal axis and configured to at least partially cover the ports to restrict flow in the flow path and at least partially uncover the ports to allow flow in the flow path;
a stem coupled to the control sleeve along the longitudinal axis and configured to move the control sleeve along the longitudinal axis to cover and uncover the ports;
a drive bushing rotationally coupled to the stem;
an actuator coupled to the drive bushing and configured to rotate the drive bushing;
a bonnet coupled to the choke body and having a bore that longitudinally engages the control sleeve; and
an anti-rotation surface formed in each of the bonnet and the control sleeve to resist rotation of the control sleeve and the stem when the drive bushing is rotated around the stem.

2. The system of claim 1, wherein the anti-rotation surface comprises one or more flat surfaces and the stem includes one or more mating flat surfaces.

3. The system of claim 1, wherein the anti-rotation surface comprises one of a spline or a spline receiver.

4. The system of claim 1, wherein the anti-rotation surface comprises one of a key and a key slot.
